(19) United States
(12) Patent Application Publication
(10) Pub. No.: US 2019/0067865 A1
(43) Pub. Date: Feb. 28, 2019

(54) CONNECTOR PAIR AND CONNECTOR

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventor: Yuji Nakura, Yokkaichi, Mie (JP)

(21) Appl. No.: 15/752,078

(22) PCT Filed: Jul. 29, 2016
(86) PCT No.: PCT/JP2016/072248

§ 371 Date: Feb. 12, 2018

(30) Foreign Application Priority Data
Aug. 19, 2015 (JP) 2015-161867

(51) Int. Cl. H01R 13/44; H01R 13/405

(52) U.S. Cl. CPC H01R 13/44; H01R 13/405

(57) ABSTRACT

The present invention restricts unauthorized access to signals without using electrical power. A second connector is configured for connection to a first connector. The first connector includes multiple first pins and a first short circuit member. The first short circuit member short-circuits a group of the first pins in an unconnected state in which the first connector is not connected to the second connector. The second connector includes multiple second pins and a short circuit canceling member. The second pins are in contact with the first pins in a connected state in which the first connector is connected to the second connector. In the connected state, the short circuit canceling member causes the first short circuit member to undergo deformation and cancels short-circuiting of the group of first pins.

### CROSS-REFERENCE TO RELATED APPLICATIONS

This application is the U.S. national stage of PCT/JP2016/072248 filed Jul. 29, 2016, which claims priority of Japanese Patent Application No. JP 2015-161867 filed Aug. 19, 2015.

### TECHNICAL FIELD

This invention relates to a connector pair and a connector.

### BACKGROUND

JP 2006-164706A discloses the following: (i) a connector of a wire harness terminal for vehicle installation is connected to a connector of an in-vehicle ECU to put the wire harness terminal and the in-vehicle ECU (Electronic Control Unit) in conduction, (ii) a determination that an abnormality occurred is made when the two aforementioned connectors change from the connected state to an uncoupled state, and (iii) a relay circuit in the connector on the wire harness terminal side cuts off the conduction path when it has been determined that an abnormality occurred.

Applying the above-described technique is desirable from the viewpoint of preventing unauthorized access to the wire harness terminal, and thus an in-vehicle LAN.

Note that JP 2013-172200A is an example of a document that introduces a relaying apparatus that functions as an in-vehicle GW (Gate Way).

However, the above-described technique requires an uncoupling determination unit for determining that an abnormality has occurred, a relay circuit, and a control circuit that sets the relay circuit to a cut-off state. If the uncoupling determination unit, the relay circuit, and the control circuit are provided inside the connector, electrical power is needed.

In view of this, an object of the present invention is to restrict unauthorized access to signals without using electrical power.

### SUMMARY

A connector pair according to a first aspect is a connector pair including a first connector and a second connector that is to be connected to the first connector, the first connector including: a plurality of first pins; and an electrically conductive first short circuit member that short-circuits a group of the first pins in an unconnected state in which the first connector is not connected to the second connector, and the second connector including: second pins that come into contact with the first pins in a connected state in which the first connector is connected to the second connector; and a first short circuit canceling member that, in the connected state, causes the first short circuit member to undergo deformation and cancels short-circuiting of the group of the first pins by the first short circuit member, wherein the first short circuit member is in contact with the first pins in the unconnected state, the first short circuit canceling member has an insulating characteristic, and enters a space between the first short circuit member and at least one of the first pins in the connected state, the first connector further includes: a main body member that fixes the first pins and the first short circuit member, the main body member has an inner circumferential side surface that faces the first pins via a gap, and the first short circuit member has one end that is fixed to the inner circumferential side surface, extends toward a side opposite to the second connector while extending from the one end toward the first pins, and is in contact with the first pins in the unconnected state.

A connector pair according to a second aspect is a connector pair including a first connector and a second connector that is to be connected to the first connector, the first connector including: a plurality of first pins; and an electrically conductive first short circuit member that short-circuits a group of the first pins in an unconnected state in which the first connector is not connected to the second connector, and the second connector including: second pins that come into contact with the first pins in a connected state in which the first connector is connected to the second connector; and a first short circuit canceling member that, in the connected state, causes the first short circuit member to undergo deformation and cancels short-circuiting of the group of the first pins by the first short circuit member, wherein the first connector further includes: a second short circuit member that is located on a side opposite to the second connector relative to the first short circuit member, and short-circuits a group of the first pins that is different from the group of the first pins that is short-circuited by the first short circuit member in the unconnected state; a first wall portion that faces the first short circuit canceling member in a connection direction of the first connector and the second connector in the connected state; and a second wall portion that is located on a side opposite to the second connector relative to the first wall portion, and the second connector includes: a second short circuit canceling member that causes the second short circuit member to undergo deformation and cancels short-circuiting of the group of the first pins by the second short circuit member in the connected state, and faces the second wall portion in the connection direction.

A connector according to a third aspect is a connector including: a plurality of first pins; and a short circuit member that short-circuits a group of the first pins, and, due to connection of the connector to a partner connector that is a connection target of the connector, deforms and cancels short-circuiting of the group of the first pins, wherein the partner connector includes: second pins that come into contact with the first pins in a connected state in which the connector is connected to the partner connector; and a short circuit canceling member that, in the connected state, causes the short circuit member to undergo deformation and cancels short-circuiting of the group of the first pins by the short circuit member, the short circuit member is in contact with the first pins in an unconnected state in which the connector is not connected to the partner connector, the short circuit canceling member has an insulating characteristic, and enters a space between the short circuit member and at least one of the first pins in the connected state, the connector further includes: a main body member that fixes the first pins and the short circuit member, the main body member has an inner circumferential side surface that faces the first pins via a gap, and the short circuit member has one end that is fixed to the inner circumferential side surface, extends toward a side opposite to the partner connector while extending from the one end toward the first pins, and is in contact with the first pins in the unconnected state.

A connector according to a fourth aspect is a connector that is to be connected to a partner connector that includes a plurality of first pins and a first short circuit member that short-circuits a group of the first pins, the connector including: second pins that come into contact with the first pins in a connected state in which the partner connector is connected to the connector; and a first short circuit canceling member that, in the connected state, causes the first short circuit member to undergo deformation and cancels short-circuiting of the group of the first pins, wherein the partner connector further includes: a second short circuit member that is located on a side opposite to the connector relative to the first short circuit member, and short-circuits a group of the first pins that is different from the group of the first pins that is short-circuited by the first short circuit member in an unconnected state in which the connector is not connected to the partner connector; a first wall portion that faces the first short circuit canceling member in a connection direction of the partner connector and the connector in the connected state; and a second wall portion that is located on a side opposite to the connector relative to the first wall portion, and the connector further includes: a second short circuit canceling member that causes the second short circuit member to undergo deformation and cancels short-circuiting of the group of the first pins by the second short circuit member in the connected state, and faces the second wall portion in the connection direction.

A connector according to a fifth aspect is a connector including: a plurality of first pins; and a first short circuit member that short-circuits a group of the first pins, and, due to connection of the connector to a partner connector that is a connection target of the connector, deforms and cancels short-circuiting of the group of the first pins, wherein the partner connector includes: second pins that come into contact with the first pins in a connected state in which the connector is connected to the partner connector; and a first short circuit canceling member that, in the connected state, causes the first short circuit member to undergo deformation and cancels short-circuiting of the group of the first pins by the first short circuit member, the connector further includes: a second short circuit member that is located on a side opposite to the partner connector relative to the first short circuit member, and short-circuits a group of the first pins that is different from the group of the first pins that is short-circuited by the first short circuit member in an unconnected state in which the connector is not connected to the partner connector; a first wall portion that faces the first short circuit canceling member in a connection direction of the connector and the partner connector in the connected state; and a second wall portion that is located on a side opposite to the partner connector relative to the first wall portion, and the partner connector further includes: a second short circuit canceling member that causes the second short circuit member to undergo deformation and cancels short-circuiting of the group of the first pins by the second short circuit member in the connected state, and faces the second wall portion in the connection direction.

### Advantageous Effects of Invention

According to the connector pair, it is possible to restrict unauthorized access to signals without using electrical power.

### BRIEF DESCRIPTION OF DRAWINGS

FIG. 1 is a cross-sectional view schematically showing an example of a configuration of a connector pair according to a first embodiment before a first connector and a second connector are connected.

FIG. 2 is a cross-sectional view schematically showing an example of the configuration of the connector pair according to the first embodiment before the first connector and the second connector are connected.

FIG. 3 is a cross-sectional view schematically showing an example of the configuration of the connector pair according to the first embodiment when the first connector and the second connector are connected.

FIG. 4 is a diagram schematically showing an example of the configuration of the connector pair according to a second embodiment before the first connector and the second connector are connected.

FIG. 5 is a diagram schematically showing an example of the configuration of the connector pair according to the second embodiment before the first connector and the second connector are connected.

FIG. 6 is a diagram schematically showing an example of the configuration of the connector pair according to the second embodiment when the first connector and the second connector are connected.

FIG. 7 is a diagram schematically showing an example of the configuration of the connector pair according to a third embodiment before the first connector and the second connector are connected.

FIG. 8 is a diagram schematically showing an example of the configuration of the connector pair according to the third embodiment before the first connector and the second connector are connected.

FIG. 9 is a diagram schematically showing an example of the configuration of the connector pair according to the third embodiment when the first connector and the second connector are connected.

### DETAILED DESCRIPTION OF PREFERRED EMBODIMENTS

### First Embodiment

FIGS. 1 to 3 are diagrams schematically showing an example of the configuration of a connector pair. The connector pair includes a first connector 1 and a second connector 3. The first connector 1 and the second connector 3 are targets for connection to each other. Accordingly, the first connector 1 is the partner connector from the viewpoint of the second connector 3, and the second connector 3 is the partner connector from the viewpoint of the first connector 1.

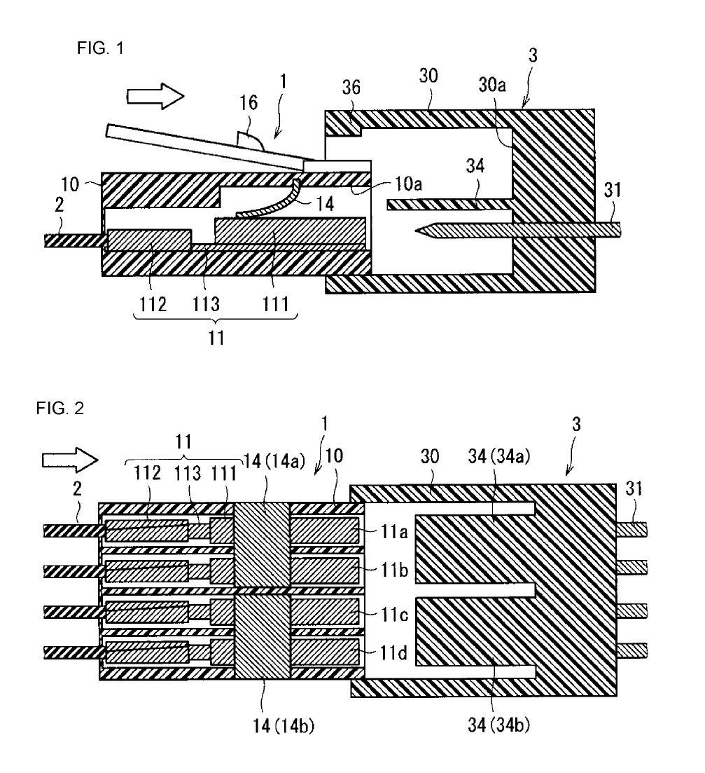

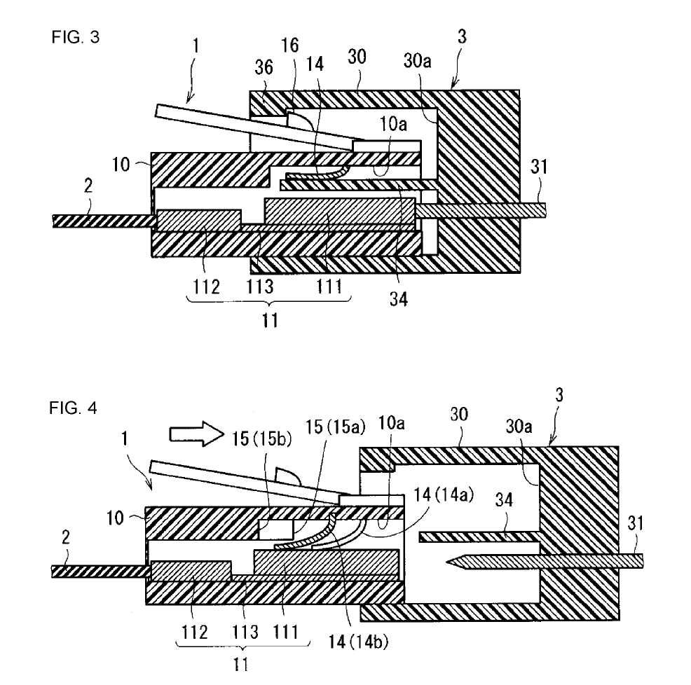

FIGS. 1 and 2 are diagrams schematically showing an example of how the first connector 1 is connected to the second connector 3, and FIG. 3 is a diagram schematically showing an example of the configuration when the first connector 1 is connected to the second connector 3. FIGS. 1 to 3 schematically show an example of the internal structures of the first connector 1 and the second connector 3. Note that in FIGS. 1 and 2, the connection direction of the first connector 1 is indicated by a block arrow. Also, although configurations are indicated with hatching in FIG. 2 as well, this was done in order to make the configurations easier to see, and does not indicate cross-sections. The same follows for FIGS. 5, and 7 to 9 as well. Hereinafter, the right side in the drawings will also be called the second connector 3 side, and the left side in the drawings will also be called the first connector 1 side.

The first connector 1 is provided at one end of electrical wires 2, for example. As shown in FIG. 2, multiple electrical wires 2 are provided, and one end of each of them is attached to the first connector 1. The other end of each of the electrical wires 2 is connected to a first electronic apparatus that is not shown. Although any apparatus may be applied as this first electronic apparatus, it is possible to apply an in-vehicle apparatus for installation in a vehicle (e.g., an in-vehicle ECU), for example.

The second connector 3 is installed in a second electronic apparatus that is not shown, for example. Although any apparatus may be applied as this second electronic apparatus, it is possible to apply an in-vehicle apparatus for installation in a vehicle, for example. As a more specific example, in the case where multiple in-vehicle ECUs are installed in a vehicle, it is possible to apply a relaying apparatus (e.g., an in-vehicle GW) that relays signals between the in-vehicle ECUs.

The first electronic apparatus and the second electronic apparatus are in electrical conduction with each other via the electrical wires 2, the first connector 1, and the second connector 3. The first electronic apparatus can thus exhibit conductive functions such as receiving power from second electronic apparatus, supplying power to the second electronic apparatus, and exchanging signals with the second electronic apparatus.

The first connector 1 includes a main body member 10, multiple pins 11, and short circuit members 14. The main body member 10 fixes the pins 11, and also fixes the short circuit members 14. In the illustration of FIG. 1, the main body member 10 accommodates the pins 11 and the short circuit members 14. This main body member 10 also functions as a connector housing that protects the pins 11 and the short circuit members 14. The main body member 10 is formed from a resin or the like.

For example, the pins 11 are crimp terminals, and each include a contact portion 111, an electrical wire fixing portion 112, and a connection portion 113 that have electrical conductivity. The pins 11 are for coming into contact with pins 31 (described later) provided in the second connector 3, and are formed from a metal, for example.

One end portion of each of the electrical wires 2 is inserted into the main body member 10 and fixed to a pin 11 inside the main body member 10. For example, the electrical wire fixing portion 112 fixes the electrical wire 2 by constricting the one end portion of the electrical wire 2 from the outer circumferential side. Also, a core wire is exposed in the one end portion of the electrical wire 2, and this core wire is in contact with the electrical wire fixing portion 112. The electrical wire fixing portion 112 and the electrical wire 2 are thus in electrical conduction.

The contact portions 111 are the portions that come into contact with the pins 31 (described later) of the second connector 3. The main body member 10 is open on the second connector 3 side and exposes the contact portions 111 such that the contact portions 111 can come into contact with the pins 31. The connection portions 113 connect the contact portions 111 to the electrical wire fixing portions 112. The contact portions 111 are thus in electrical conduction with the electrical wires 2 via the connection portions 113 and the electrical wire fixing portions 112. In other words, the pins 11 are in electrical conduction with the electrical wires 2. In this structure, when the contact portions 111 come into contact with the pins 31, the electrical wires 2 enter a state of electrical conduction with the pins 31 via the pins 11.

The short circuit members 14 have electrical conductivity and are deformable. The short circuit members 14 each short-circuit multiple pins 11 when the first connector 1 and the second connector 3 are in an unconnected state (FIGS. 1 and 2) of not being connected. In the illustration of FIG. 2, short circuit members 14a and 14b are shown as two short circuit members 14, and pins 11a to 11d are shown as four pins 11. The four pins 11a to 11d are in contact with respective electrical wires 2, and are arranged side-by-side in a predetermined direction (e.g., a direction orthogonal to the connection direction). Also, the pins 11a to 11d are arranged side-by-side in the stated order. The short circuit member 14a short-circuits the pins 11a and 11b in the unconnected state, and the short circuit member 14b short-circuits the pins 11c and 11d, which are different from the pins 11a and 11b that are short-circuited by the short circuit member 14a, in the unconnected state. Hereinafter, when there is no need to distinguish between the pins 11a to 11d, they will be simply called pins 11, and when there is no need to distinguish between the short circuit members 14a and 14b, they will be simply called short circuit members 14.

In the illustration of FIG. 1, the short circuit members 14 are metal plates, and one end of each is fixed to an inner circumferential side surface 10a of the main body member 10. Among the inner circumferential side surfaces of the main body member 10, the inner circumferential side surface 10a is an inner circumferential side surface that faces the pins 11. This inner circumferential side surface 10a faces the pins 11 via a gap. The short circuit members 14 extends toward the pins 11 from the one end, and comes into contact with multiple pins 11 (here, two adjacent pins 11; see FIG. 2 as well). In the illustration of FIG. 1, the short circuit members 14 extend so as to move away from the second connector 3 (i.e., move toward the electrical wires 2) while extending from the inner circumferential side surface 10a of the main body member 10 toward the pins 11.

The short circuit members 14 have elasticity in this example, and deform under an external force. More specifically, one end (the end on the inner circumferential side surface 10a side) of each of the short circuit members 14 is a fixed end, and the other end (the end on the pin 11 side) deforms as a free end, for example. For example, when the short circuit member 14 (particularly the contact portion that comes into contact with the pins 11) is pushed toward the inner circumferential side surface 10a, the short circuit member 14 deforms with the one end serving as the fixed end, and moves away from the pins 11. Short-circuiting of the pins 11 is thus canceled. Also, the short circuit member 14 has elasticity sufficient for again coming into contact with the pins 11 when no longer subjected to the external force.

Also, the second connector 3 includes a main body member 30, multiple pins 31, and short circuit canceling members 34. The main body member 30 has a recessed shaped with an opening on the first connector 1 side, and the first connector 1 is inserted into the main body member 30. The main body member 30 is formed from a resin or the like.

The pins 31 are fixed to the main body member 30. The pins 31 have electrical conductivity, and come into contact with the pins 11 (more specifically the contact portions 111) of the first connector 1. The pin 31 are formed from a metal, for example. The pins 31 are male pins, and the pins 11 are female pins, for example. The pins 31 pass through the main body member 30, and are connected to an electric component (e.g., a printed circuit board; not shown) in the second electronic apparatus outside of the main body member 30.

In the connected state, the short circuit canceling members 34 press and deform the short circuit members 14 of the first connector 1 so as to cancel the short-circuiting of the pins 11 (see FIG. 3 as well). In the illustration of FIG. 2, the number of short circuit canceling members 34 corresponds to the number of short circuit members 14 (two). For example, two short circuit canceling members 34a and 34b are provided in correspondence with the two short circuit members 14a and 14b. In the connected state, the short circuit canceling member 34a presses and deforms the short circuit member 14a so as to cancel the short-circuiting of the pins 11a and 11b. In the connected state, the short circuit canceling member 34b presses and deforms the short circuit member 14b so as to cancel the short-circuiting of the pins 11c and 11d. Note that hereinafter, when there is no need to distinguish between the short circuit canceling members 34a and 34b, they will be simply called short circuit canceling members 34.

For example, the short circuit canceling members 34 protrude toward the first connector 1 from an inner circumferential surface 30a of the main body member 30. In the illustration of FIG. 1, the inner circumferential surface 30a is a surface that opposes the first connector 1 in the connection direction. The short circuit canceling members 34 have a plate-like shape, and also have a substantially rectangular shape, for example. The short circuit canceling members 34 are insulating members, for example, and are formed from a resin or the like. The short circuit canceling members 34 may be formed unified with the main body member 30, for example. Manufacturing can thus be made easier. The short circuit canceling members 34 are provided at positions facing the short circuit members 14 in the connection direction, and the length of the short circuit canceling members 34 in the connection direction is set to a length sufficient for pressing the short circuit members 14 in the connected state (see FIG. 3 as well).

In this connector pair, when the first connector 1 is inserted into the second connector 3, the short circuit canceling members 34 abut against the short circuit members 14. When the first connector 1 is further pressed into the second connector 3, the short circuit members 14 are pushed upward toward the inner circumferential side surface 10a due to external force from the short circuit canceling members 34. The short circuit members 14 thus move away from the pins 11, and the short-circuiting of the pins 11 is canceled.

Note that in the illustration of FIG. 1, the short circuit members 14 extend so as to move away from the second connector 3 while extending from the inner circumferential side surface 10a of the main body member 10 toward the pins 11, and are in contact with the pins 11 in the unconnected state. Accordingly, when the short circuit members 14 and the pins 11 are in contact with each other, they substantially form a V shape with an opening on the second connector 3 side. Because the short circuit members 14 extend so as to move away from the second connector 3 in this way, the short circuit canceling members 34 can more easily press the short circuit members 14 toward the inner circumferential side surface 10a than in the case where the short circuit members 14 extend in the opposite direction. In other words, the short circuit canceling members 34 easily enter the space between the short circuit members 14 and the pins 11. By then inserting the first connector 1 to a predetermined position in the second connector 3, the first connector 1 and the second connector 3 become appropriately connected, and the pins 11 appropriately come into contact with the pins 31.

Note that in the illustration of FIGS. 1 and 3, the first connector 1 is provided with a locking portion 16, and the second connector 3 is provided with a locking portion 36. The locking portions 16 and 36 are separate from the essence of the present embodiment, and therefore will only be described briefly here. The locking portions 16 and 36 lock with each other in the connected state and suppress withdrawal of the first connector 1 from the second connector 3. In the case of removing the first connector 1 from the second connector 3, a user withdraws the first connector 1 from the second connector 3 while pressing down the locking portion 16 so as to cancel the locking.

As described above, according to this connector pair, in the connected state, the pins 11 of the first connector 1 and the pins 31 of the second connector 3 come into contact with each other, and the short-circuiting of the pins 11 by the short circuit members 14 is canceled. The pins 11 are thus appropriately in electrical conduction with the pins 31 in one-to-one correspondence. Conductive functions for the first connector 1 and the second connector 3 can thus be exhibited. Specifically, signals applied to the pins 11 from the electrical wires 2 can be appropriately transmitted to the pins 31, and conversely, signals applied to the pins 31 can be appropriately transmitted to the pins 11.

On the other hand, in the unconnected state before the first connector 1 is connected to the second connector 3, groups of pins 11 are short-circuited by the short circuit members 14 as described above. Accordingly, even if an unauthorized third party connects an unauthorized apparatus that lacks the short circuit canceling members to the first connector 1, signals cannot be appropriately received from the first electronic apparatus via the short-circuited pins 11, and signals cannot be appropriately transmitted to the first electronic apparatus via the short-circuited pins 11. It is therefore possible to restrict access to signals by the unauthorized third party.

Also, when the first connector 1 is withdrawn from the second connector 3, for example, the short circuit members 14 undergo elastic restoration and short-circuit the pins 11 again. Accordingly, even if the first connector 1 is connected to the second connector 3, and thereafter the first connector 1 is withdrawn from the second connector 3, it is possible to restrict unauthorized access to signals. Moreover, whereas power is needed to restrict unauthorized access to signals in JP 2006-164706A, such power is not needed in the present embodiment.

Insulation between pins 11 and short circuit members 14

Note that in the illustration of FIG. 3, the short circuit canceling members 34 that have an insulating characteristic enter the space between (are located between) the short circuit members 14 and the pins 11 in the connected state. Accordingly, it is possible to increase the insulation distance between the short circuit members 14 and the pins 11. In comparison with a structure that will be described next, this contributes to a decrease in the size of the first connector 1 (particularly the size in the opposing direction in which the short circuit members 14 and the pins 11 oppose each other, that is to say the size in the vertical direction with respect to the paper surface in FIG. 3). For example, in the case where the short circuit canceling members 34 are formed from an electrically conductive material, a gap needs to be formed between the short circuit canceling members 34 and the pins 11. In order to realize the same insulation distance as in the case of applying insulating short circuit canceling members 34, it is necessary to ensure a large distance between the electrically conductive short circuit canceling members 34 and the pins 11, and this increases the size of the first connector 1. Note that although a gap is formed between the short circuit canceling members 34 and the pins 11 in FIG. 3, if the short circuit canceling members 34 have an insulating characteristic, the short circuit canceling members 34 may come into contact with the pins 11.

From the viewpoint of the insulation distance, it is sufficient that the insulating short circuit canceling members 34 exist in at least the opposing region in which the pins 11 and the short circuit members 14 oppose each other. For example, as shown in FIG. 3, it is sufficient that the leading ends of the short circuit canceling members 34 are located on the electrical wire 2 side of the leading ends of the short circuit members 14 in the connected state. This can be realized by appropriately setting the positions of the short circuit members 14 and the lengths thereof in the connection direction, as well as the lengths of the short circuit canceling members 34 in the connection direction. Accordingly, the short circuit members 14 face the pins 11 with the insulating short circuit canceling members 34 therebetween in the entire region of the short circuit members 14 in the connection direction.

Also, as shown in FIG. 2, it is sufficient that the width of each of the short circuit canceling members 34 (width in the arrangement direction in which the pins 11 are arranged side-by-side) is set approximately the same as or wider than the width of the group of pins 11 that are the short-circuit targets. Accordingly, the pins 11 face the short circuit members 14 with the short circuit canceling members 34 therebetween in the entire region of the pins 11 in the arrangement direction thereof.

Short-Circuit Targets

Note that in the above-described examples, the four pins 11a to 11d are all short-circuit targets. However, a pin 11 that is not short-circuited by a short circuit member 14 may be provided in the first connector 1. In other words, the short circuit member 14 need only short-circuit at least two of the pins 11. This is because it is therefore possible to restrict access to signals via the short-circuited pins 11.

### Second Embodiment

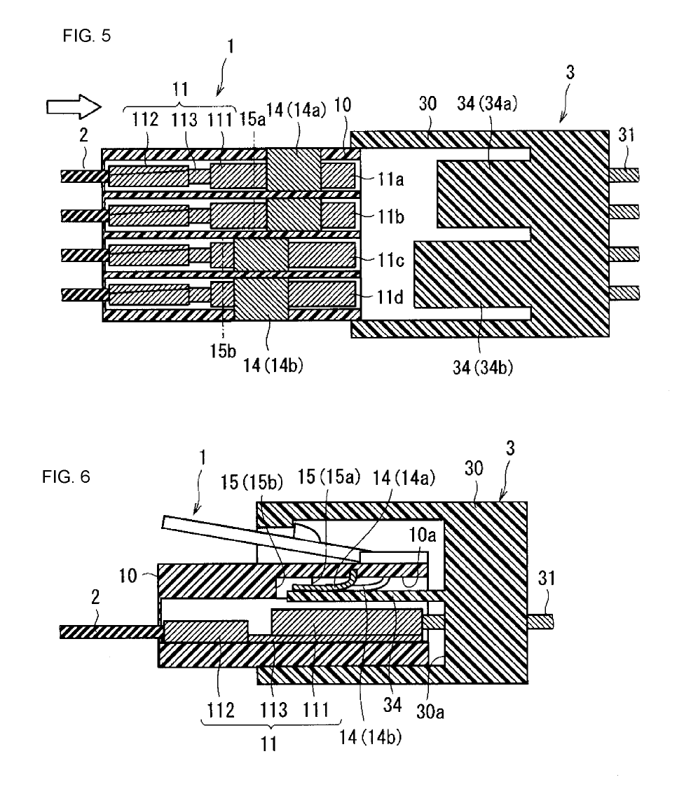

FIGS. 4 to 6 are diagrams schematically showing another example of the first connector 1 and the second connector 3. FIGS. 4 and 5 are diagrams schematically showing an example of how the first connector 1 is connected to the second connector 3. FIG. 6 is a diagram schematically showing an example of the configuration when the first connector 1 is connected to the second connector 3.

In a second embodiment, multiple short circuit members 14 are provided in the first connector 1. In the illustration of FIG. 5, two short circuit members 14a and 14b are provided. In the second embodiment, the positions of the short circuit members 14a and 14b in the connection direction are different from each other. For example, the short circuit member 14b is located on the side opposite to the second connector 3 relative to the short circuit member 14a.

The second connector 3 is provided with multiple short circuit canceling members 34 in correspondence with the short circuit members 14. In the illustration of FIG. 5, two short circuit canceling members 34a and 34b are provided in correspondence with the two short circuit members 14a and 14b.

In the illustration of FIG. 5, the positional relationship of the short circuit members 14a and 14b in the connection direction and the magnitude relationship of the lengths of the short circuit canceling members 34a and 34b in the connection direction are in correspondence with each other. Specifically, the length of the short circuit canceling member 34b is set longer than the length of the short circuit canceling member 34a in correspondence with the short circuit member 14b that is farther from the second connector 3 than the short circuit member 14a is. In other words, the length of the short circuit canceling member 34b that is necessary to press the short circuit member 14b is longer than the length of the short circuit canceling member 34a that is necessary to press the short circuit member 14a, and therefore the lengths of the short circuit canceling members 34a and 34b are set as described above.

Moreover, the first connector 1 is provided with multiple obstruction walls in correspondence with the short circuit members 14 and the short circuit canceling members 34. In the illustration of FIG. 4, two wall portions 15a and 15b are provided as obstruction walls that correspond to the two short circuit members 14a and 14b and the two short circuit canceling members 34a and 34b. The wall portion 15a is provided in correspondence with the short circuit member 14a and the short circuit canceling member 34a, and the wall portion 15b is provided in correspondence with the short circuit member 14b and the short circuit canceling member 34b. Hereinafter, when there is no need to distinguish between the wall portions 15a and 15b, they will be simply called wall portions 15.

As shown in FIG. 6, the wall portions 15 are located on the side opposite to the second connector 3 relative to the corresponding short circuit members 14. For example, the wall portion 15a is located on the side opposite to the second connector 3 relative to the short circuit member 14a, and the wall portion 15b is located on the side opposite to the second connector 3 relative to the short circuit member 14b. Also, in the connected state, the wall portions 15 face the corresponding short circuit canceling members 34 in the connection direction. For example, the wall portion 15a faces the short circuit canceling member 34a, and the wall portion 15b faces the short circuit canceling member 34b. These wall portions 15 are formed as steps in the inner circumferential side surface 10a of the main body member 10, for example.

The positional relationship of the wall portions 15a and 15b in the connection direction is set in correspondence with the positional relationship of the short circuit members 14a and 14b and the magnitude relationship of the lengths of the short circuit canceling members 34a and 34b. Specifically, similarly to the positional relationship of the short circuit member 14a and 14b, the wall portion 15b is located on the side opposite to the second connector 3 relative to the wall portion 15a. In the illustration of FIG. 5, the positions of the wall portions 15a and 15b in the connection direction are indicated by chain lines. Also, in the connected state, the short circuit canceling member 34b, which is longer than the short circuit canceling member 34a, extends farther toward the wall portion 15b than the wall portion 15a does, and faces the wall portion 15b (FIG. 6).

With this connector pair, when the first connector 1 is inserted into the second connector 3, and these two are connected, the short circuit canceling members 34a and 34b respectively press the short circuit members 14a and 14b and cancel the short-circuiting of the pins 11 while respectively facing the wall portions 15a and 15b via a gap. According to this connection, the pins 11 and 31 appropriately enter a state of electrical conduction in one-to-one correspondence, similarly to the first embodiment.

The positional relationship of the wall portions 15a and 15b, the positional relationship of the short circuit members 14a and 14b, and the magnitude relationship of the lengths of the short circuit canceling members 34a and 34b function as a key (called a connection key) that determines the suitability of the connection of the first connector 1 and the second connector 3. This will be described in detail below.

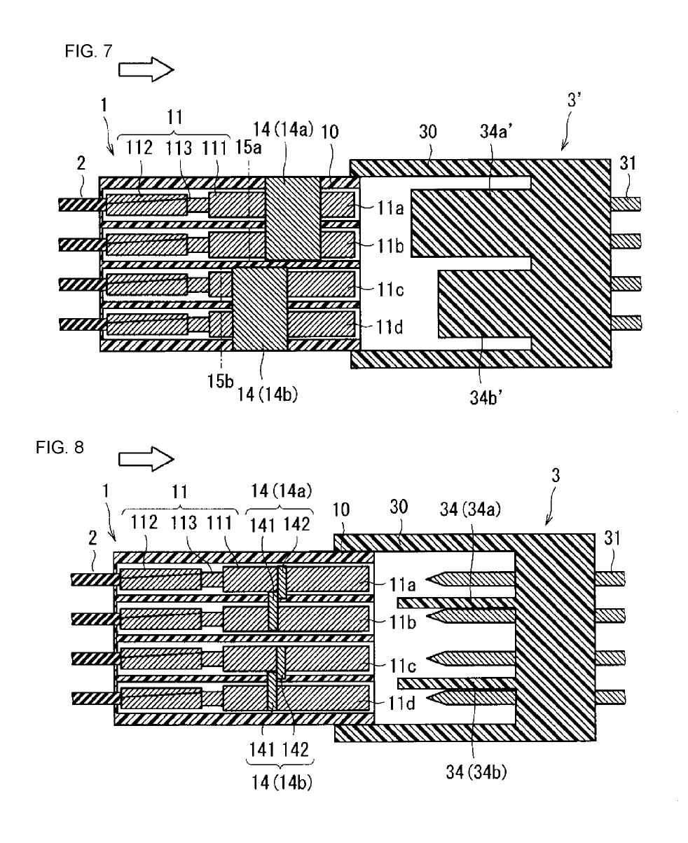

For example, in the illustration of FIG. 7, a second connector 3′ is shown as the connection target for the first connector 1. This second connector 3′ is different from the second connector 3 in that short circuit canceling members 34a′ and 34b′ are provided in place of the short circuit canceling members 34a and 34b respectively. The short circuit canceling member 34a′ is provided in correspondence with the short circuit member 14a, and the short circuit canceling member 34b′ is provided in correspondence with the short circuit member 14b. The lengths of the short circuit canceling members 34a′ and 34b′ are set opposite to the lengths of the short circuit canceling members 34a and 34b of the second connector 3. In other words, the length of the short circuit canceling member 34a′ in the connection direction is the same as that of the short circuit canceling member 34b, and the length of the short circuit canceling member 34b′ in the connection direction is the same as that of the short circuit canceling member 34a.

When the first connector 1 is inserted into this second connector 3′, the short circuit canceling member 34a′ collides with the wall portion 15a, and connection is inhibited. In other words, the short circuit canceling member 34a′ is longer than necessary with respect to the position of the wall portion 15a. This second connector 3′ is not suited to the first connector 1.

Also, even if the length of the short circuit canceling member 34a′ is set appropriately with respect to the wall portion 15a, the short circuit canceling member 34b′ is short and therefore cannot appropriately press the short circuit member 14b, and there are cases where the short-circuiting of the pins 11c and 11d cannot be canceled. In such a case, although the first connector 1 and the second connector 3′ can be physically connected, the pins 11c and 11d cannot be electrically separated, and therefore the first connector 1 is not appropriately in electrical conduction with the second connector 3′. In other words, the short circuit canceling member 34b′ is set shorter than necessary with respect to the position of the short circuit member 14b, and this second connector 3′ is not suited to the first connector 1.

As described above, the positional relationship between the short circuit members 14 and the wall portions 15 in the connection direction and the magnitude relationship of the lengths of the short circuit canceling members 34 function as a connection key that determines the suitability of the combination of the first connector 1 and the second connector 3.

Accordingly, if an unauthorized second connector 3′ that is not compatible with the first connector 1 is used, the first connector 1 and the second connector 3′ cannot be appropriately connected. It is thus possible to restrict an unauthorized third party from accessing signals with use of an unauthorized connector.

Note that in view of the function as a connection key, it is desirable that the gap between the wall portions 15a and 15b in the connection direction is long. The reason for this is that the more the wall portions 15a and 15b are separated from each other, the more the lengths of the short circuit canceling members 34a and 34b need to be different, thus making it possible to exclude connection with a connector that has short circuit canceling members 34a and 34b with approximately the same length.

Accordingly, as illustrated in FIG. 5, it is sufficient that the wall portion 15b, the short circuit member 14b (more specifically, the contact portion that comes into contact with the pins 11c and 11d), the wall portion 15a, and the short circuit member 14a (more specifically, the contact portion that comes into contact with the pins 11a and 11b) are arranged in the stated order in the direction from the first connector 1 toward the second connector 3. This is because it is possible to set the gap between the wall portions 15a and 15b longer than in the case where the wall portion 15a is located between the wall portion 15b and the short circuit member 14b.

Also, the distance between a wall portion 15 and a short circuit member 14 (more specifically, a contact portion that comes into contact with pins 11) that correspond to each other may be short. A high clearance is thus required for the lengths of the short circuit canceling members 34a and 34b. This is because it is thus possible to exclude connection with a connector that does not satisfy this requirement.

### Third Embodiment

FIG. 8 is a diagram schematically showing an example of the configuration of a connector pair. In the illustration of FIG. 8, each short circuit member 14 includes an electrically conductive first member 141 and an electrically conductive second member 142. The first member 141 is in contact with and fixed to one of adjacent pins 11, and the second member 142 is in contact with and fixed to the other one of the adjacent pins 11. For example, one end of the first member 141 of the short circuit member 14a is in contact with and fixed to the pin 11b, and one end of the second member 142 of the short circuit member 14a is in contact with and fixed to the pin 11a.

Also, the first member 141 and the second member 142 are in contact with each other in the unconnected state. For example, the first member 141 and the second member 142 of the short circuit member 14a extend so as to approach each other, and the leading end portions thereof, which are not fixed, face each other and are in contact with each other. Accordingly, the adjacent pins 11a and 11b are short-circuited via the short circuit member 14a. In the illustration of FIG. 8, the first member 141 is located on the side opposite to the second connector 3 relative to the second member 142.

The first member 141 has elasticity, and deforms when subjected to force acting toward the side opposite to the second connector 3. Specifically, with the fixing portion fixed to the pin 11 serving as the fulcrum, the first member 141 bends to the side opposite to the second connector 3 and moves away from the second member 142. Short-circuiting of the pins 11 is thus canceled. Also, the first member 141 has sufficient elasticity for again coming into contact with the second member 142 when the first connector 1 is withdrawn from the second connector 3, for example.

The short circuit canceling members 34 of the second connector 3 extend toward the first connector 1, and are provided at positions opposing the first members 141. The short circuit canceling members 34 have an insulating characteristic, for example.

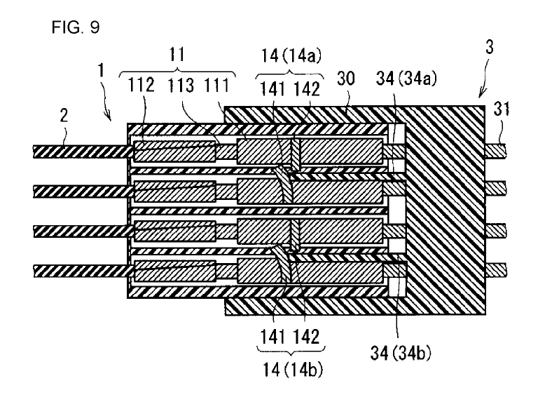

In this connector pair, when the first connector 1 is inserted into the second connector 3, the leading ends of the short circuit canceling members 34 abut against the first members 141. When the first connector 1 is further pressed into the second connector 3, the short circuit canceling members 34 press the first members 141 to the side opposite to the second connector 3. The first members 141 thus deform and separate from the second members 142 (see FIG. 9). The short-circuiting of the pins 11 is thus canceled.

As described above, in the third embodiment as well, when the first connector 1 is connected to the second connector 3, the short-circuiting of the pins 11 is canceled, and the pins 11 and 31 come into contact with each other. Accordingly, the pins 11 and 31 are appropriately electrically connected, and the first connector 1 and the second connector 3 can be appropriately connected.

Also, in the unconnected state before connection, the pins 11 are short-circuited by the short circuit members 14. Similarly to the first embodiment, it is thus possible to restrict access to signals by a unauthorized third party. Also, by withdrawing the first connector 1 from the second connector 3 for example, the first members 141 again come into contact with the second members 142 and short-circuit the pins 11. Accordingly, even if the first connector 1 is mated with the second connector 3, and thereafter the first connector 1 is withdrawn from the second connector 3, it is possible to restrict unauthorized access to signals.

The configurations described in the above embodiments and variations can be appropriately combined as long as no contradiction arises. For example, the second embodiment can be applied to the third embodiment as well.

Although this invention has been described in detail above, the above description is illustrative in all respects, and this invention is not limited to the above description. It will be understood that numerous variations not illustrated here can be envisioned without departing from the range of this invention.

1. A connector pair comprising a first connector and a second connector that is to be connected to the first connector,
the first connector comprising:
a plurality of first pins; and
an electrically conductive first short circuit member that short-circuits a group of the first pins in an unconnected state in which the first connector is not connected to the second connector, and
the second connector comprising:
second pins that come into contact with the first pins in a connected state in which the first connector is connected to the second connector; and
a first short circuit canceling member that, in the connected state, causes the first short circuit member to undergo deformation and cancels short-circuiting of the group of the first pins by the first short circuit member,
wherein the first short circuit member is in contact with the first pins in the unconnected state,
the first short circuit canceling member has an insulating characteristic, and enters a space between the first short circuit member and at least one of the first pins in the connected state,
the first connector further comprises:
a main body member that fixes the first pins and the first short circuit member,
the main body member has an inner circumferential side surface that faces the first pins via a gap, and
the first short circuit member has one end that is fixed to the inner circumferential side surface, extends toward a side opposite to the second connector while extending from the one end toward the first pins, and is in contact with the first pins in the unconnected state.

2. The connector pair according to claim 1,
wherein the first connector further comprises:
a second short circuit member that is located on a side opposite to the second connector relative to the first short circuit member, and short-circuits a group of the first pins that is different from the group of the first pins that is short-circuited by the first short circuit member in the unconnected state;
a first wall portion that faces the first short circuit canceling member in a connection direction of the first connector and the second connector in the connected state; and
a second wall portion that is located on a side opposite to the second connector relative to the first wall portion, and
the second connector comprises:
a second short circuit canceling member that causes the second short circuit member to undergo deformation and cancels short-circuiting of the group of the first pins by the second short circuit member in the connected state, and faces the second wall portion in the connection direction.

3. A connector pair comprising a first connector and a second connector that is to be connected to the first connector,
the first connector comprising:
a plurality of first pins; and
an electrically conductive first short circuit member that short-circuits a group of the first pins in an unconnected state in which the first connector is not connected to the second connector, and
the second connector comprising:
second pins that come into contact with the first pins in a connected state in which the first connector is connected to the second connector; and
a first short circuit canceling member that, in the connected state, causes the first short circuit member to undergo deformation and cancels short-circuiting of the group of the first pins by the first short circuit member,
wherein the first connector further comprises:
a second short circuit member that is located on a side opposite to the second connector relative to the first short circuit member, and short-circuits a group of the first pins that is different from the group of the first pins that is short-circuited by the first short circuit member in the unconnected state;
a first wall portion that faces the first short circuit canceling member in a connection direction of the first connector and the second connector in the connected state; and
a second wall portion that is located on a side opposite to the second connector relative to the first wall portion, and
the second connector comprises:
a second short circuit canceling member that causes the second short circuit member to undergo deformation and cancels short-circuiting of the group of the first pins by the second short circuit member in the connected state, and faces the second wall portion in the connection direction.

4. The connector pair according to claim 3,
wherein the first short circuit member is in contact with the first pins in the unconnected state, and
the first short circuit canceling member has an insulating characteristic, and enters a space between the first short circuit member and at least one of the first pins in the connected state.

5. A connector comprising:
a plurality of first pins; and
a short circuit member that short-circuits a group of the first pins, and, due to connection of the connector to a partner connector that is a connection target of the connector, deforms and cancels short-circuiting of the group of the first pins
wherein the partner connector comprises:
second pins that come into contact with the first pins in a connected state in which the connector is connected to the partner connector; and
a short circuit canceling member that, in the connected state, causes the short circuit member to undergo deformation and cancels short-circuiting of the group of the first pins by the short circuit member,
the short circuit member is in contact with the first pins in an unconnected state in which the connector is not connected to the partner connector,
the short circuit canceling member has an insulating characteristic, and enters a space between the short circuit member and at least one of the first pins in the connected state,
the connector further comprises:
a main body member that fixes the first pins and the short circuit member,
the main body member has an inner circumferential side surface that faces the first pins via a gap, and
the short circuit member has one end that is fixed to the inner circumferential side surface, extends toward a side opposite to the partner connector while extending from the one end toward the first pins, and is in contact with the first pins in the unconnected state.

6. A connector that is to be connected to a partner connector that comprises a plurality of first pins and a first short circuit member that short-circuits a group of the first pins, the connector comprising:
second pins that come into contact with the first pins in a connected state in which the partner connector is connected to the connector; and
a first short circuit canceling member that, in the connected state, causes the first short circuit member to undergo deformation and cancels short-circuiting of the group of the first pins,
wherein the partner connector further comprises:
a second short circuit member that is located on a side opposite to the connector relative to the first short circuit member, and short-circuits a group of the first pins that is different from the group of the first pins that is short-circuited by the first short circuit member in an unconnected state in which the connector is not connected to the partner connector;
a first wall portion that faces the first short circuit canceling member in a connection direction of the partner connector and the connector in the connected state; and
a second wall portion that is located on a side opposite to the connector relative to the first wall portion, and
the connector further comprises:
a second short circuit canceling member that causes the second short circuit member to undergo deformation and cancels short-circuiting of the group of the first pins by the second short circuit member in the connected state, and faces the second wall portion in the connection direction.

7. A connector comprising:
a plurality of first pins; and
a first short circuit member that short-circuits a group of the first pins, and, due to connection of the connector to a partner connector that is a connection target of the connector, deforms and cancels short-circuiting of the group of the first pins,
wherein the partner connector comprises:
second pins that come into contact with the first pins in a connected state in which the connector is connected to the partner connector; and
a first short circuit canceling member that, in the connected state, causes the first short circuit member to undergo deformation and cancels short-circuiting of the group of the first pins by the first short circuit member,
the connector further comprises:
a second short circuit member that is located on a side opposite to the partner connector relative to the first short circuit member, and short-circuits a group of the first pins that is different from the group of the first pins that is short-circuited by the first short circuit member in an unconnected state in which the connector is not connected to the partner connector;
a first wall portion that faces the first short circuit canceling member in a connection direction of the connector and the partner connector in the connected state; and
a second wall portion that is located on a side opposite to the partner connector relative to the first wall portion, and
the partner connector further comprises:
a second short circuit canceling member that causes the second short circuit member to undergo deformation and cancels short-circuiting of the group of the first pins by the second short circuit member in the connected state, and faces the second wall portion in the connection direction.
